(19) United States
(12) Patent Application Publication
(10) Pub. No.: US 2025/0044135 A1
(43) Pub. Date: Feb. 6, 2025

(54) METHOD FOR DETERMINING A SIMULATED CURRENT MASS FLOW IN A COOLANT CIRCUIT

(71) Applicant: Robert Bosch GmbH, Stuttgart (DE)

(72) Inventor: Christian Dullinger, Wien (AT)

(21) Appl. No.: 18/718,974

(22) PCT Filed: Dec. 8, 2022
(86) PCT No.: PCT/EP2022/084939

§ 371 Date: Jun. 12, 2024

(30) Foreign Application Priority Data
Dec. 15, 2021 (DE) 10 2021 214 374.1
Feb. 28, 2022 (DE) 10 2022 202 021.9

(51) Int. Cl. G01F 1/88

(52) U.S. Cl. CPC G01F 1/88

(57) ABSTRACT

The invention relates to a method for determining a simulated current mass flow (m_IV), in particular as a substitute for a current mass flow (m_IM) that cannot be measured in a field/production vehicle, in a coolant circuit (10) for heating/cooling a component (20) to be heated/cooled, the method comprising the steps of: receiving pressure data (D_P), wherein the pressure data (D_P) comprise a first pressure (p1) in the coolant circuit (10) and a second pressure (p2) in the coolant circuit (10), wherein the first pressure (p1) is provided from a first pressure-measuring point and the second pressure (p2) is provided from a second pressure-measuring point, or the pressure data (D_P) comprise a pressure differential (Δp) in the coolant circuit (10), wherein the pressure differential (Δp) between the first pressure-measuring point and the second pressure-measuring point is provided; wherein the first pressure-measuring point is upstream of the second pressure-measuring point and wherein the first pressure-measuring point and the second pressure-measuring point are in the same coolant path of the coolant circuit (10); determining the simulated current mass flow (m_IV) of the coolant with the aid of a mathematical model (M) which is suitable for determining the current mass flow based on the pressure data (D_P).

### BACKGROUND

The present invention relates to a method for determining a simulated current mass flow in a coolant circuit via a virtual mass flow sensor, which can be used in particular to adjust a target mass flow.

Certain components to be heated/cooled (i.e., heat sources or heat sinks from the coolant's point of view) in a cooling circuit require that not only their coolant inlet temperature be regulated, but also the coolant differential temperature, i.e., coolant outlet temperature minus coolant inlet temperature. In the simplest case, a cooling circuit having only one component to be heated/cooled (e.g., a fuel cell stack), a radiator, a bypass valve and a coolant pump, the coolant inlet temperature of the component to be heated/cooled can be achieved by mixing a cold coolant mass flow coming from the radiator with a hot coolant mass flow that does not flow through the radiator and has thus been heated directly by the component to be cooled. The mixing of these two mass flows is performed by a continuously variable bypass valve. Given that the bypass valve thus defines the coolant inlet temperature, the requirement to regulate the coolant differential temperature via the component can therefore also be considered as a requirement to regulate the coolant outlet temperature to match the current coolant inlet temperature. The more coolant mass flow is pumped through the component, the closer the coolant outlet temperature approaches the coolant inlet temperature despite the heat dissipation of the component to be cooled, i.e., the coolant differential temperature approaches zero. Therefore, the coolant differential temperature or coolant outlet temperature is regulated via the coolant mass flow delivered by the coolant pump through the component. For this purpose, a target rotational speed of the coolant pump is required and calculated by the software running on the controller. There are various prior art methods for calculating the target rotational speed of the coolant pump, which will be further explained hereinafter. However, these prior art methods have various disadvantages, which are also further explained hereinafter. However, the target rotational speed of the coolant pump can also be calculated by the method proposed in this invention, which is particularly advantageous if the cooling circuit is very complex and consists of a plurality of coolant lines, coolant pumps, valves, radiators, heaters, and components to be heated/cooled coupled to one another via branches and merges. This will be explained in detail hereinafter. Finally, to avoid misunderstandings, it should be briefly mentioned that the adjustment of the calculated target rotational speed of the coolant pump is usually performed by a hardware-based rotational speed controller (in a control loop at the lowest hierarchy level), which is sometimes already installed in the coolant pump itself and is not the subject matter of this document.

In order to achieve the required coolant target mass flow through a component to be cooled (sometimes also to be heated) for a desired coolant differential temperature or coolant outlet temperature, according to the prior art, a controller is used in what is referred to as the forward path, which calculates the target rotational speed of the coolant pump (for the subordinate hardware-based rotational speed controller).

In this case, the desired coolant target mass flow is divided by the temperature-dependent calculated density, resulting in the desired coolant target flow rate. The desired coolant target flow rate is multiplied by the temperature-dependent calculated viscosity correction factor, resulting in the viscosity-corrected desired coolant target flow rate. The desired target rotational speed for the coolant pump is ultimately determined via a two-dimensional characteristic map, which depends on the desired mass flow ratio that is set by the bypass valve and the viscosity-corrected desired coolant target flow rate. Therefore, this is purely a control system (and not a regulation system) that requires complex characteristic maps and tests on the test bench, e.g., starting up the operating points, which are defined by the support points of the characteristic maps/characteristic curves and must be repeated for the smallest changes to the system, e.g., a different pump, different coolant line, or different bypass valve.

Given that the higher-level temperature regulator for the coolant differential temperature (or coolant outlet temperature) of the component to be heated/cooled (heat source or heat sink), e.g. a fuel cell stack or a battery, requires the current coolant mass flow for the control concept, but the coolant current mass flow in the production vehicle is not measured via a mass flow sensor (or flow rate sensor), there is also what is referred to as a reverse path, which is structured in the same way as the forward path. In this case, in the reverse path the actual rotational speed reported back by the coolant pump and the actual position of the bypass valve are used in the calculation. In the reverse path, there is also a characteristic map, which is referred to as the inverse characteristic map, and the temperature-dependent calculated viscosity correction factor and the temperature-dependent calculated density are also included again. However, as the current coolant mass flow is determined here only via a back-calculation based on actuator positions, i.e., bypass valve position and pump rotational speed, this current coolant mass flow cannot be used for a regulator whose control variable is the target rotational speed of the coolant pump. In the case of a fuel cell power module (also referred to as multi-box), in which several fuel cell stacks are coupled in a very customized manner via a common complex cooling circuit, some components (radiators, heaters, etc.) can be shared so that further valves/branches/merges are present, the following applies: Everything affects everything. Two-dimensional characteristic maps are no longer sufficient because multiple valves and multiple pumps are provided. The calibration effort for the characteristic maps and correction factors would be immense.

Another prior art method that calculates the pressure loss over the entire cooling circuit in order to then calculate the required target rotational speed of the coolant pump that is required to achieve a desired target mass flow is also a control system and not a regulation system and therefore cannot compensate for model errors of the models of cooling circuit components used. In addition, this prior art method requires that the entire cooling circuit, which is sometimes very complex and customer-specific, must be modeled with regard to the pressure losses and then such a model must also be calibrated and, in addition, various actuator positions (e.g., valve positions) must also be considered in the calculation of such a model during operation. In addition to the creation, calibration, maintenance and the fact that this concept cannot compensate for model errors (key phrase: control and no regulation), such a model also requires a very high computing power in the control unit of the production vehicle for the pressure losses in the entire cooling circuit and thus has many disadvantages.

### SUMMARY

According to one aspect of the invention, a method for determining a simulated current mass flow, in particular as a substitute for a current mass flow that can no longer be measured in the field/production vehicle, in a coolant circuit for heating/cooling a component to be heated/cooled comprises the following steps: In one step, pressure data is received, whereby the pressure data comprise a first pressure in the coolant circuit and a second pressure in the coolant circuit, whereby the first pressure is provided from a first pressure-measuring point and the second pressure is provided from a second pressure-measuring point, or the pressure data comprise a pressure differential in the coolant circuit, whereby the pressure differential between the first pressure-measuring point and the second pressure-measuring point is provided. The first pressure-measuring point is upstream of the second pressure-measuring point and the first pressure-measuring point and the second pressure-measuring point are in the same coolant path of the coolant circuit.

In a further step, the simulated current mass flow of the coolant is determined with the aid of a mathematical model and/or characteristic map, which is suitable for determining the simulated current mass flow based on the pressure data.

Preferably, the pressure-measuring points comprise measuring points in which a pressure sensor or a differential pressure sensor is arranged.

Preferably, the simulated current mass flow, in particular as a substitute for a current mass flow that cannot be measured in the field/production vehicle, is used in a control loop that is used to adjust a target mass flow (i.e., the guide variable of this control loop), which is required in a coolant path of a component to be heated/cooled, for heating/cooling of this component.

The coolant circuit preferably comprises a plurality of coolant paths. A coolant path of the coolant circuit is characterized in that the same coolant mass flow prevails everywhere in the coolant path. In other words, no coolant mass flow is branched off or added along a coolant path. Ideally, the coolant path in which the pressure-measuring points are located is the coolant path in which the component to be heated/cooled is also located. If this is not the case, however, the simulated current mass flow in the coolant path can still be determined if the division between the mass flows of the relevant coolant paths is known, e.g., because the bypass valve reports back its actual position and the valve characteristic of the bypass valve is known.

The mathematical model and/or the characteristic map implemented in the controller software is also referred to as a virtual mass flow sensor, as it determines the current mass flow based on the pressure data instead of measuring the current mass flow via one or more flow rate or mass flow sensor(s).

From the point of view of the coolant circuit, the component to be heated/cooled is a heat source or a heat sink.

In the case of a data-based black box model or gray box model, the measured current mass flow of the coolant in the coolant path in which the first pressure-measuring point and the second pressure-measuring point are located must be able to be determined on the test bench or in a test vehicle in order to provide the trained mathematical model. For example, the current mass flow is measured directly via at least one mass flow sensor or is calculated via at least one flow rate sensor and the coolant density. Therefore, the measured current mass flow of the coolant is available as the target output variable for the system identification of the mathematical model as well as for its validation. Typically, flow rate sensors are installed on the test bench and the density can also be calculated, particularly depending on the temperature, using the coolant data, in particular a coolant data sheet, and the existing coolant temperature sensors.

In the field/production vehicle, in particular the automobile, in which the method for determining the simulated current mass flow is performed, the mass flow sensor or flow rate sensor(s) are not/no longer required. Instead, only the signals described hereinabove, in particular the pressure data, have to be processed and provided as inputs to the virtual mass flow sensor implemented in the software. On this basis, the virtual mass flow sensor calculates the simulated current mass flow of the coolant as its initial variable. Depending on what was ultimately implemented in the software, the virtual mass flow sensor is an identified black box model, an identified gray box model, a white box model, or a characteristic map that is calibrated therewith. The term “virtual mass flow sensor” comes from the fact that the current mass flow in the field/production vehicle is not determined directly by a physical mass flow sensor or flow rate sensor, which isn't present there, but via a mathematical model, i.e. black box model, gray box model or characteristic map, which was created on the basis of data, in particular from data from a test bench or data from a test vehicle that was provided with an additional mass flow sensor or flow rate sensor, or a purely analytical white box model.

Therefore, the simulated current mass flow determined via the virtual mass flow sensor can be used for a regulation system in which the regulator in particular specifies the target rotational speed of the coolant pump, which regulates a desired target coolant mass flow, which is required in particular for regulating the coolant temperature at the coolant outlet of the component to be heated/cooled (e.g., fuel cell stack, battery, etc.).

The creation of the trained black box model, or the gray box model, comprises a training (i.e., identifying parameters) of the corresponding model. The test bench or test vehicle preferably directly comprises sensors directly for determining a measured current mass flow, the output variable of the black box model, or the gray box model, and thus the target variable of the training or system identification. In the context of neural networks, this is referred to as training and, in the context of polynomials and splines, as identifying/estimating. If there is no mass flow sensor on the test bench or in the test vehicle, but only a flow rate sensor, the coolant temperature in the area of the flow rate sensor must be known reasonably accurately in order to be able to calculate the temperature-dependent density of the coolant in the area of the flow rate sensor and thus ultimately to be able to calculate the indirectly measured current mass flow of the coolant at the test bench/in the test vehicle, which is required for the identification/training of the black box model or the gray box model. The subsequent application (e.g., in a control loop in which the target mass flow is the guiding variable), for example in a fuel cell vehicle, or an electrical vehicle, requires these sensors, i.e. mass flow sensor or flow rate sensor plus temperature sensor in the area of the flow rate sensor, then no longer, as the virtual mass flow sensor, which is implemented in the controller software in the production vehicle, can be used to determine the simulated current mass flow.

Preferably, there are various ways of implementing the virtual mass flow sensor in the software, which then runs on the controller of the production vehicle. The virtual mass flow sensor can be implemented in the software as a black box model (e.g., neural network, multi-dimensional polynomial, multi-dimensional spline, etc.), as a gray box model, which is based on physical formulas (e.g., Bernoulli equation with pressure loss and mass conservation) and describes individual variables (e.g. coefficient of resistance) using a black box model (e.g., neural network, multi-dimensional polynomial, multi-dimensional spline, etc.) or implemented as an analytical white box model, or the black box or gray box model or white box model is used to generate the data for a characteristic map (i.e., the support point values of the dependent variables of the characteristic map).

To create the black box model or gray box model for determining the simulated current mass flow, the measurement data (i.e., in particular the pressure, temperature and mass flow data) collected on the test bench or in the test vehicle are divided into different data sets, in particular training data, validation data and simulation data. The black box model, in particular comprising a neural network, i.e., a machine learning model, is trained using the training data. The validation data is used for model selection, i.e., choice of model complexity. The simulation data are used to independently verify the quality of the identified model as the simulation data is not used in any way in the creation of the model.

Preferably, the number of support points per input of the characteristic map is specified when a characteristic map is calibrated using the identified black box model, gray box model or white box model. The inputs of the characteristic map and the black box model and gray box model or white box model must be the same signals.

Preferably, the positions of the support points of the characteristic map (i.e., the support point values of the independent variables of the characteristic map) are optimized. Preferably, the position of the smallest support point and the largest support point are predetermined for each input of the characteristic map.

To create the black box model or gray box model, it is not necessary to approach special operating points or to perform special tests. Measurement data (i.e., in particular the pressure, temperature and mass flow data) already generated during different tests on the test bench or in the test vehicle can simply be used for the identification of the black box model or the gray box model. The black box model or the gray box model can then either be implemented directly in the software, which then runs on the controller of the production vehicle, or used to calibrate a characteristic map, which is then implemented in the software.

Therefore, the method presented here for calibration of a characteristic map via a black box model and/or gray box model represents an immense time and cost saving compared with the conventional method of obtaining the data required by the grid of a characteristic map (i.e. the values of the dependent variables of the characteristic map), namely the time-consuming, difficult and often only inaccurately possible approach from one support point after the other and measurement of the associated dependent variable on the test bench/in the test vehicle.

As flow rate sensors or mass flow sensors are installed on the test bench, the mass flow can be calculated or measured for the test bench and is therefore available as the output variable/target variable for the system identification of the black box model or the gray box model. In the production vehicle, the flow rate sensors or mass flow sensors are then no longer needed. However, the at least one flow rate sensor or mass flow sensor should not be mounted between the pressure-measuring points on the test bench/in the test vehicle, as its absence in the production vehicle would result in a change in the components between the corresponding first pressure-measuring point and the second pressure-measuring point. This would affect the relationship between the pressure loss and mass flow and thus change it, making the identified model less suitable. The system limit of the system described by the model (i.e., either the data-based black box model, the data-based gray box model, or the purely analytical white box model) is the area of the coolant path between the pressure-measuring points (i.e., from the first pressure-measuring point to the second pressure-measuring point). If something changes in this area, e.g. different coolant, different piping, component added or removed, etc., a black box (i.e., a purely data-based model) or a gray box model (i.e., a data-based model whose model structure was created analytically) must be identified again, or a white box model (i.e., a purely analytically created model) must be modified in its analytical structure.

A viscosity of the coolant is typically temperature-dependent.

Preferably, the component to be heated/cooled (i.e., the heat source/heat sink from the point of view of the coolant) comprises a fuel cell stack. However, it could also be a battery, an inverter, an electric motor, a heater, or the like.

Preferably, the data-based black box model or gray box model is a two-dimensional mathematical mapping of the simulated current mass flow of the coolant, depending on the pressure data, in particular the pressure differential. A multi-dimensional mapping (i.e., more than two inputs), for example depending on the first pressure and the second pressure, and some temperatures that approximate the temperature distribution between the pressure-measuring points, would have the following disadvantages compared to the two-dimensional mapping: A multi-dimensional mapping is graphically more complex and more difficult to visualize and/or verify. The input space would be weaker with the measurement data. This is particularly critical in the system identification or, in other words, the identification of the black box model or the gray box model, if only a few measured values for the pressure signals and temperature signals and the signal of the directly or indirectly measured current mass flow or the actual flow rate were collected at the test bench/test vehicle, or if these occur only in certain areas of the input space. The computing effort both for the system identification and the calculation of the model in the controller increases with the number of model inputs (i.e., the input dimensions). If the black box model or the gray box model are not intended to be directly implemented in the software (in this case, the virtual mass flow sensor would be the black box model or the gray box model in the software), and instead use the model for calibrating a characteristic map (in this case, the virtual mass flow sensor would be the characteristic map in the software), then the problem arises that only two-dimensional maps are common in the software (i.e., templates such as the library blocks in Matlab SIMULINK are available for this purpose).

However, the first pressure and the second pressure and multiple coolant temperatures approximating the actual temperature distribution between the first pressure-measuring point and the second pressure-measuring point can also be selected as independent inputs for the model

Using the described method, it is not necessary to model and calculate the pressure loss over the entire cooling circuit in order to achieve the desired target mass flow. Instead, the pressures (or pressure differential) measured in the coolant path that serve as input signals for the virtual mass flow sensor can be used to calculate the simulated current mass flow as an output signal of the virtual mass flow sensor and feed this simulated current mass flow to a controller for adjusting a target mass flow.

The prior art method for calculating the pressure loss over the entire cooling circuit in order to then calculate the rotational speed so that a required target mass flow is achieved is a control system, and not a regulating system, so it cannot compensate for model errors. In other words, the entire cooling circuit, which is sometimes very complex and customer-specific, must be modeled with regard to the pressure losses and then such a model must also be calibrated and, in addition, various actuator positions (e.g., valve positions) must also be considered in the calculation of such a model during operation. In addition to the creation, calibration, maintenance and the fact that this concept cannot compensate for model errors (key phrase: this is a control system and not a regulating system), such a model also requires a very high computing power for the pressure losses in the entire cooling circuit and thus has many disadvantages.

Therefore, the method enables the simulated current mass flow of the coolant in the production vehicle to be determined despite the absence of a physical mass flow sensor or flow rate sensor in the production vehicle, and in particular to be used for a controller whose guide variable is the target coolant mass flow. In the production vehicle, the simulated current mass flow can be determined by the so-called virtual mass flow sensor, whose input signals are built up from the signals measured at the pressure-measuring points and whose output signal is the simulated current mass flow.

In this way, an improved method for determining a simulated current mass flow in a coolant circuit is provided.

In a preferred embodiment, the mathematical model comprises an identified black box model that is purely data-based.

As a black box model, the mathematical model does not require any geometry data of the coolant circuit, but only the pressure data or, if the temperature dependence of the coolant viscosity cannot be disregarded, the temperature data. Data of the directly measured current mass flow or the current mass flow calculated from the measurement data, which was provided in particular by the test bench or test vehicle via additional sensors (i.e., mass flow sensors or flow rate sensors), are only required for the creation, i.e., identification, of the black box model.

In a preferred embodiment, the black box model comprises a polynomial, a spline, or a machine learning model (e.g., neural network).

In a preferred embodiment, the mathematical model comprises an identified gray box model that models at least portions of a physical relationship between pressure, temperature, and mass flow.

Preferably, the temperature is only required if the temperature dependence of the coolant viscosity cannot be disregarded.

The mathematical model requires a gray box model depending on the level of detail of the physical equations of the gray box model used (e.g., Bernoulli equation with pressure loss and mass conservation) and can also include geometry data of the coolant circuit (e.g., flow cross-sections and geodetic height at the locations of the first pressure-measuring point and the second pressure-measuring point).

In a preferred embodiment, the mathematical model comprises a white box model that fully analytically models the physical relationship between pressure, temperature and/or mass flow. The need for temperatures and/or heating flows depends on how the model is set up and what (i.e., which component, which coolant) is within the system limit (system limit is from the first pressure-measuring point to the second pressure-measuring point).

As a white box model, the mathematical model requires all details (i.e., detailed geometry data, coolant data, thermodynamic ratios) over the range of the coolant path between the pressure-measuring points (i.e., from the first pressure-measuring point to the second pressure-measuring point).

In the case of a fluidic relationship that can be modeled analytically very accurately (e.g., very precisely known coolant data, very simple or very precisely known geometry and thermodynamic conditions between the pressure-measuring points) between pressure differential, mass flow and temperature-dependent viscosity, the virtual mass flow sensor can sometimes also be created as an analytical model, a so-called white box model.

In a preferred embodiment, the mathematical model calibrates a characteristic map, whereby the simulated current mass flow is determined based on the characteristic map, whereby the characteristic map comprises a plurality of data points that associate the simulated current mass flow with the pressure data and/or temperature data.

In other words, the virtual mass flow sensor comprises a characteristic map that has been calibrated using the black box model, gray box model, or white box model.

Preferably, the number of support points per input of the characteristic map is specified when a characteristic map is calibrated using the identified black box model, gray box model or white box model obtained purely analytically. The inputs of the characteristic map and the black box model and gray box model or white box model must be the same physical variables. In the case of a time-discrete dynamic mathematical model (dynamic black box model or gray box model or white box model), the additionally required inputs of the characteristic map can be provided by dead-time blocks arranged upstream (i.e., externally).

To create the data-based black box model or gray box model, it is not necessary to approach special operating points or to perform special tests. All measurement data already generated during different tests on the test bench/in the test vehicle can simply be used for the identification of the data-based black box model or the gray box model. The black box model or the gray box model can then either be implemented directly in the software, or used to calibrate a characteristic map, which is then implemented in the software of the controller.

Therefore, the method presented here for calibration of a characteristic map via a data-based black box model and/or gray box model represents an immense time and cost saving compared with the conventional method of obtaining the data required by the grid of a characteristic map (i.e. the values of the dependent variables of the characteristic map), namely the time-consuming, difficult and often only inaccurately possible approach from one support point value after the other and measurement of the associated dependent variable on the test bench/in the test vehicle.

Preferably, the positions of the support points of the characteristic map (i.e., the support point values of the independent variables of the characteristic map) are optimized. Preferably, the position of the smallest support point and the largest support point are predetermined for each input of the characteristic map.

Preferably, a static black box model or gray box model or white box model are used comparatively easily for the calibration of a characteristic map, which can then be implemented very easily in the software. The characteristic map makes it possible to avoid having to implement the black box model or gray box model or white box model directly in software. The characteristic map sometimes requires significantly less computing effort compared to the black box model or gray box model or white box model. The characteristic map also provides a direct insight into the data points stored in the characteristic map. The characteristic map also enables improved process validation during the development process. The characteristic map also protects the disclosed know-how being applied because the characteristic map only reveals that relationship between the mass flow, i.e., the simulated current mass flow, and the pressure data and preferably the temperature data, are taken into consideration. In other words, with the aid of the mathematical model (black box Model, gray box model or white box model), a characteristic map can be calibrated very simply via simulation. In addition, the choice of the support locations of the map can be optimized to achieve good calculation results even with a few support locations. In the case that the black box model is a polynomial or a spline, either the polynomial or the spline can be implemented directly in software or can also be used for the calibration of a characteristic map. A characteristic map requires more variables to be stored than a polynomial. However, a characteristic map is more robust in terms of extrapolation compared to a polynomial. In the case of a polynomial, calibration errors or resolution errors, in particular value quantization inaccuracies of the polynomial coefficients, may sometimes have an immense effect on the calculated result.

Preferably, a static machine learning model, in particular a static neural network, is more powerful than a polynomial in describing the relationship between simulated current mass flow and pressure data and/or temperature data.

In the case that the virtual mass flow sensor is implemented as a characteristic map in the software, the position of the support points of the independent variables (i.e. the position of the grid points) of this characteristic map can also be optimized in advance by means of mathematical optimization (e.g., sequential quadratic programming), such that for a predetermined data set associated with the relevant operating range, the e.g., summed quadratic error between the simulated current mass flow calculated by the black box model or gray box model or white box model and the simulated current mass flow rate calculated by the characteristic map optimized with regard to the position of the support points becomes a minimum.

Therefore, even if the pre-selected number of support points per input of the characteristic map is only small, and thus the number of grid points of the map is small, the output (i.e., in this case the simulated current mass flow rate) of the virtual mass flow sensor (i.e., the dependent variable of the characteristic map) can be calculated very accurately in the relevant operating range. By selecting fewer but optimized support sites (i.e. grid points) in terms of their position, a great deal of memory can be saved to store the characteristic map values (i.e., the numerical values of the independent variables and their associated dependent variables), and yet the required accuracy of the model output (i.e., simulated current mass flow) of the virtual mass flow sensor (in this case implemented as an optimized characteristic map) can be met.

In the following, the algorithm, i.e., the method for optimizing the position of the support sites, is described:

The black box model and gray box model or white box model NN uses the mathematical mapping y_{NN}=NN(u₁, u₂) to calculate its model output y_{NN} depending on its inputs (here the two inputs u₁ and u₂). Specifically, in a preferred embodiment, u₁=p₁−p₂=Δp is the pressure differential Δp between the pressure-measuring points and u₂=T is the representative temperature T that the temperature distribution of the coolant approximates between the first pressure-measuring point and the second pressure-measuring point to account for temperature-dependent viscosity. Specifically, y_{NN} is the current mass flow simulated by the black box model or gray box model or white box model NN.

The characteristic map M calculates its model output y_{Map} using the mathematical mapping y_{Map}=M(u₁, u₂) depending on its inputs (here the two inputs u₁ and u₂). The model output y_{Map} is calculated for specific values of the inputs u₁ and u₂ that do not lie on grid points of the characteristic map M, preferably using interpolation.

For a specific (here two-dimensional) characteristic map M, x_{1,1}, . . . , x_{1,n}_{₁} and x_{2,1}, . . . , x_{2,n}_{₂} refer to the positions (sorted by size in ascending order) of the support points (i.e., grid points) of the independent variables (i.e., variables whose dimension correspond to those of the inputs u₁ and u₂). In other words, the number of support point positions for the input u₁ of the characteristic map M is n₁ and the number of support point positions for the input u₂ of the characteristic map M is n₂. The (in this case two-dimensional) characteristic map M therefore includes n₁*n₂ grid points. Preferably, the smallest value x_{i,1}, or the largest value x_{i,n}_{ᵢ} per input dimension i of the characteristic map M (here in the case of two inputs u₁ and u₂: i=1,2 applies) is specified by the developer/calibrator.

In the specific case, the following cost function J(x₁, x₂) is used to optimize the position of the support points (of the independent variables) x_{i,k}_{ᵢ} (for i=1, 2 and kᵢ=2, . . . , nᵢ−1) for a given number of support points n; per input dimension i (i.e., per input uᵢ; für i=1,2).

$$\begin{matrix}min \\ \{ {x}_{1} , {x}_{2} \}\end{matrix} J ( {x}_{1} , {x}_{2} ) = \begin{matrix}min \\ \{ {x}_{1} , {x}_{2} \}\end{matrix} {\sum }_{j = 1}^{N} {( {y}_{Map , j} ( {x}_{1} , {x}_{2} ) - {y}_{NN , j} )}^{2} = \begin{matrix}min \\ \{ {x}_{1} , {x}_{2} \}\end{matrix} {\sum }_{j = 1}^{N} {( M ( {x}_{1} , {x}_{2} , {u}_{1 , j} , {u}_{2 , j} ) - NN ( {u}_{1 , j} , {u}_{2 , j} ) )}^{2}$$

$$where$$

$${x}_{i , {k}_{i}} > {x}_{i , 1} ∀ {k}_{i} ∈ \{ 2 , {n}_{i} - 1 \} ; ∀ i ∈ \{ 1 , 2 \}$$

$${x}_{i , {k}_{i}} < {x}_{i , {n}_{i}} ∀ {k}_{i} ∈ \{ 2 , {n}_{i} - 1 \} ; ∀ i ∈ \{ 1 , 2 \}$$

$$with$$

$${x}_{1} = \{ {x}_{1 , 2} , … , {x}_{1 , {n}_{1} - 1} \}$$

$$and$$

$${x}_{2} = \{ {x}_{2 , 2} , … , {x}_{2 , {n}_{2} - 1} \}$$

The notation y_{Map,j}(x₁, x₂) or M(x₁, x₂, u_{1,j}, u_{2,j}) clarifies that the characteristic map output or characteristic map depends on the decision vector of the optimization {x₁, x₂}. The index j refers to a single data sample of the data set used (e.g., simulation data set) with N data samples.

Each individual data sample j for which either u_{i,j}<x_{1,1} or u_{i,j}>x_{i,n}_{ᵢ} (for i=1, 2) applies is discarded to avoid extrapolation of the characteristic map M.

For example, the initial values of xᵢ can be selected such that the values x_{i,k}_{ᵢ} (for kᵢ=2, . . . , nᵢ−1) are equidistant between x_{i,1} and x_{i,n}_{ᵢ} (for i=1, 2).

During each iteration step of optimization with changed values of the decision vector {x₁, x₂}, the associated values (i.e., the values z_{2,1}, z_{1,2}, z_{2,2}, . . . , zₖ_{₁}_{,k}_{₂}′ . . . , zₙ_{₁}_{-1,n}_{₂}₋₁, zₙ_{₁}_{, n}_{₂}₋₁, zₙ_{₁}_{-1,n}_{₂},) of the dependent variable z (i.e., the output dimension of the characteristic map; in other words, the dimension of the output y_{Map}) of the characteristic map M are obtained by simulating each discrete combination of x₁ and x₂ (i.e., {x_{1,2},x_{2,1}}, {x_{1,1}, x_{2,2}}, {x_{1,2},x_{2,2}}, . . . , {x_{1,k}_{₁}, x_{2,k}_{₂}}, . . . {x_{1,n}_{₁}₋₁,x_{2,n}_{₂}₋₁}, {x_{1,n}_{₁}, x_{2,n}_{₂}₋₁}, {x_{1,n}_{₁}₋₁, x_{2,n}_{₂}}) over zₖ_{₁}_{,k}_{₂}=NN(x_{1,k}_{₁}, x_{2,k}_{₂}) (i.e., for all grid points of the characteristic map M except for the corners). Note that when the algorithm is initialized, the corners also need to be simulated using NN(.,.), but as the corners are not part of the decision vector {x₁, x₂}, they no longer change during optimization, and therefore the values z_{1,1}, zₙ_{₁}_{,1}, z_{1,n}_{₂} and zₙ_{₁}_{,n}_{₂} no longer change.

The result of the optimization is an optimized characteristic map M with non-uniform but optimized grid spacings of the grid, the output \tilde{y}_{Map} of which (here the simulated current mass flow) is calculated via the mathematical mapping \tilde{y}_{Map}=\tilde{M}(u₁, u₂).

Compared to a characteristic map with evenly distributed grid spacings, the optimized position of the support points x_{i,k}_{ᵢ} can achieve accurate results for the output even with few support points. As a result, memory space can be saved for storing the support points of the characteristic map (i.e., for storing the values {x_{1,k}_{₁}, x_{2,k}_{₂}} and zₖ_{₁}_{,k}_{₂}).

In one preferred embodiment, the method comprises the following steps: receiving temperature data of the coolant circuit; determining a representative temperature from the temperature data, whereby the representative temperature approximates the temperature distribution of the coolant between the first pressure-measuring point and the second pressure-measuring point; determining the simulated current mass flow of the coolant with the aid of the mathematical model that determines the simulated current mass flow based on the pressure data (D_P) and the temperature data (D_T), or based on the pressure data and the determined representative temperature.

In principle, the method can also be used without any approximate consideration of the temperature distribution of the coolant between the first pressure-measuring point and the second pressure-measuring point, however, depending on the coolant used, a less accurate result for the simulated current mass flow calculated by the model must then be expected.

In other words, the actual temperature distribution between the first pressure-measuring point and the second pressure-measuring point is approximated by a representative temperature calculated from the measured temperature signals.

Therefore, the number of input dimensions, i.e., the number of inputs of the model, can be minimized.

The temperature data are suitable to describe the actual temperature distribution of the coolant between the first pressure-measuring point and the second pressure-measuring point with sufficient accuracy and simplicity. This is done in order to be able to include the influence of the mostly temperature-dependent viscosity of the coolant, which in turn depends on the actual (not completely measurable) temperature distribution in the coolant, on the relationship between pressure differential (pressure differential between the first and the second pressure-measuring point) and coolant mass flow in the mathematical description of the physical relationship.

In other words, the temperature data comprises at least one temperature signal which is suitable for describing the coolant temperature distribution prevailing between the first pressure-measuring point and the second pressure-measuring point, in particular in the flow direction of the coolant, preferably with sufficient accuracy, i.e., to approximate it in a simplified manner.

The actual time-varying temperature distribution between the first pressure-measuring point and the second pressure-measuring point is infinitely dimensional, as it is a distribution, and therefore cannot be completely measured. The representative temperature thus represents an estimate of the temperature distribution. The appropriate choice of representative temperature, particularly for a simplified description of the actual unknown temperature distribution between the pressure-measuring points, i.e., the pressure sensors, depends on the position of the pressure-measuring points.

Since the coolant viscosity has an impact on the pressure losses and thus also on the relationship between pressure differential and mass flow, the representative temperature aims to capture this temperature-dependent relationship as simply as possible in the case of a temperature-dependent coolant viscosity.

In a preferred embodiment, the representative temperature comprises linear interpolation between a temperature at the coolant inlet of a heat source or a heat sink and a temperature at the coolant outlet of a heat source or heat sink (e.g., the component to be heated/cooled).

If the first pressure-measuring point is upstream and the second pressure-measuring point is downstream of the heat source or heat sink (e.g., fuel cell stack), a linear interpolation between the measured coolant temperature at the coolant inlet of the heat source or heat sink and the coolant temperature at the coolant outlet of the heat source or heat sink is a comparatively good approximation of the temperature profile, as heat is absorbed or released by the coolant during operation. For example, the following formula describes the representative temperature:

$$T = {T}_{1} * ( 1 - f ) + {T}_{2} * f$$

where T₁ the coolant temperature at the coolant inlet of the heat source or the heat source represents T₂ the coolant temperature at the coolant outlet of the heat source or heat sink. A value between 0 and 1 can be selected for the factor f (e.g., f=0.5).

In a preferred embodiment, the mathematical model was trained on a test bench or a test vehicle, whereby the test bench or the test vehicle additionally had one or more flow rate or mass flow sensor(s).

This process involves receiving mass flow data (D_M), in which case the mass flow ratios between the different coolant paths must sometimes also be received as mass flow ratio data (D_MV) in order to receive the mass flow data (D_M), depending on the position of the mass flow sensors or flow rate sensors.

According to an aspect of the invention, an apparatus for determining a simulated current mass flow, in particular as a substitute for a current mass flow that can no longer be measured in the field/production vehicle, in a coolant circuit for cooling or heating a component to be heated/cooled, said apparatus being configured to perform the method as described herein.

According to one aspect of the invention, the simulated current mass flow as determined according to a method as described herein is used in a control loop for adjusting a target mass flow required in the coolant path of the component to be cooled/heated, for cooling/heating this component.

Preferably, a target rotational speed of a coolant pump which pumps the coolant through the coolant circuit is determined by a regulator. In other words, the coolant pump is the actuator and the target rotational speed of the coolant pump is the variable of this control loop. For this purpose, a PI or PID control loop with anti-windup is preferably used, which takes into account the rotational speed limits (i.e., the manipulated variable limits) of the coolant pump. In the case of a single degree of freedom regulator, the input to the regulator is therefore a regulation deviation between the target mass flow and the current mass flow. In the case of a two degree of freedom regulator, the inputs to the regulator are therefore the target mass flow and the current mass flow. In other words, the coolant pump is regulated depending on the predetermined mass flow and the current mass flow. If the current mass flow is not measured via one or more flow rate sensor(s) or mass flow sensor(s), the simulated current mass flow can be determined/simulated via the virtual mass flow sensor presented.

The computer program preferably comprises instructions that, when the computer program is executed by a computer, prompt the latter to perform a method for determining a simulated current mass flow in a coolant circuit which is suitable for adjusting a target mass flow required for cooling or heating a component.

Further measures improving the invention are described in greater detail hereinafter, together with the description of the preferred exemplary embodiments of the invention, with reference to the drawings.

### BRIEF DESCRIPTION OF THE DRAWINGS

Shown are:

FIG. 1 a one-box coolant circuit;

FIG. 2a a multi-box coolant circuit;

FIG. 2b three one-boxes connected to a multi-box:

FIG. 3 a control loop for adjusting a target mass flow in the coolant path of the component to be heated/cooled via the target rotational speed of a coolant pump of a coolant circuit;

FIG. 4 the creation and checking of the black box and gray box model;

FIG. 5a various implementation variants of the virtual mass flow sensor;

FIG. 5b further various implementation variants of the virtual mass flow sensor; and

FIG. 5c further various implementation variants of the virtual mass flow sensor.

### DETAILED DESCRIPTION

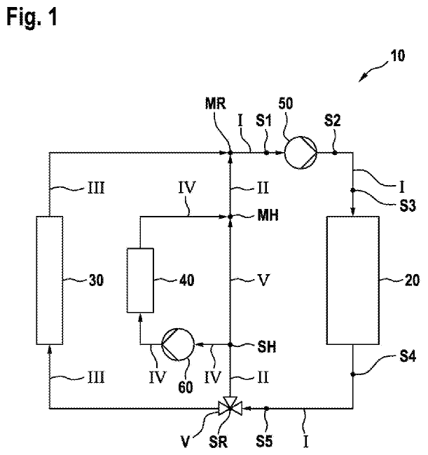

FIG. 1 shows a coolant circuit 10 of an exemplary one-box (also known as a Fuel Cell System (FCS)). The coolant circuit comprises a component 20 to be heated/cooled, e.g., a fuel cell stack, a cooling device 30, a heater 40, a coolant pump 50, and a heating path coolant pump 60. The component 20 being heated/cooled is located in a first coolant path I in which a certain current mass flow (not detected by a sensor) prevails. The task is to influence the rotational speed of the coolant pump 50 such that the target mass flow required by the higher-level temperature regulation (regulation of the coolant differential temperature above or of the coolant outlet temperature from the component 20 to be heated/cooled) is set in the first coolant path I. The cooling device 30, for example a radiator, is located in the third coolant path III. The coolant mass flow of the first coolant path I can be divided into a second coolant path II and the third coolant path III in any desired ratio via a continuously adjustable bypass valve V. The bypass valve V can be positioned either at a first mixing point MR of the second coolant path II and the third coolant path III or at the first branching point SR of the second coolant path II and the third coolant path III. The heater 40 is located in a fourth coolant path IV. In addition, the heating path coolant pump 60 associated with the heater 40 is located in the fourth coolant path IV. The second coolant path II divides at the second branch point SH into the fourth coolant path IV and a fifth coolant path V, which is reunited at a second mixing point MH to the second coolant path II. In an alternative embodiment (not shown), the fourth coolant path IV is not connected to the second coolant path II but to the first coolant path I, preferably upstream of the component 20.

In the first coolant path I, a first measuring point S1, a second measuring point S2, a third measuring point S3, a fourth measuring point S4 and a fifth measuring point S5 are shown, at each of which a temperature sensor and/or pressure sensor can each be arranged. The first measuring point S1 is located between the first mixing point MR and the coolant pump 50. The second measuring point S2 is located between the coolant pump 50 and the component 20 to be heated/cooled near the coolant pump 50. The third measuring point S3 is located between the coolant pump 50 and the component 20 to be heated/cooled near the component 20 to be heated/cooled. The fourth measuring point S4 is located between the component 20 to be heated/cooled and the branch point SR near the component 20 to be heated/cooled. The fifth measuring point S5 is located between the component 20 to be heated/cooled and the first branch point SR near the first branch point SR.

Preferably, the temperature sensors are arranged such that they enable the temperature distribution between pressure sensors in the third measuring point S3 and the fourth measuring point S4 to be approximated well in order to take the temperature-dependent viscosity into account.

In the event that the pressure sensors, i.e. pressure-measuring points, are upstream and downstream of a heat source/heat sink, e.g. the component 20 to be cooled/heated, (from the point of view of the coolant: a heat source absorbs heat from the coolant; a heat sink absorbs heat from the coolant), the temperature dependency of the coolant viscosity cannot be disregarded, and the temperature sensors are also upstream and downstream of the heat source/heat sink, it makes sense (in order to keep the dimensionality, i.e. the number of inputs, of the data-based model low) to introduce what is referred to as the representative temperature T. This representative temperature T can then be provided as an input to the data-based model to account for the influence of temperature-dependent coolant viscosity.

For example, linear interpolation between the first temperature T1 and the second temperature T2 is applied. The representative temperature T in this case is determined from the following formula:

$$T = {T}_{1} * ( 1 - f ) + {T}_{2} * f$$

A value between 0 and 1 can be selected for the factor f (e.g., f=0.5).

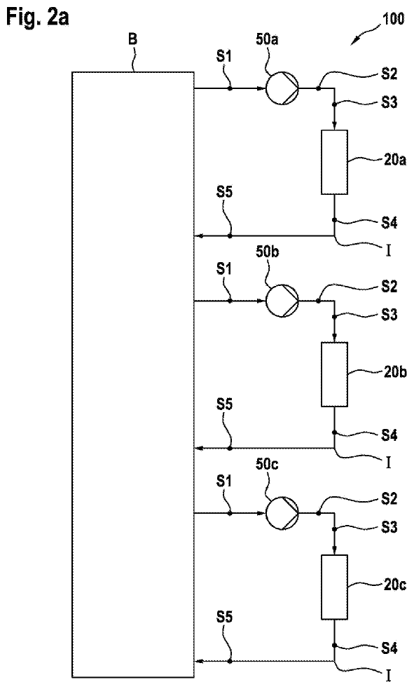

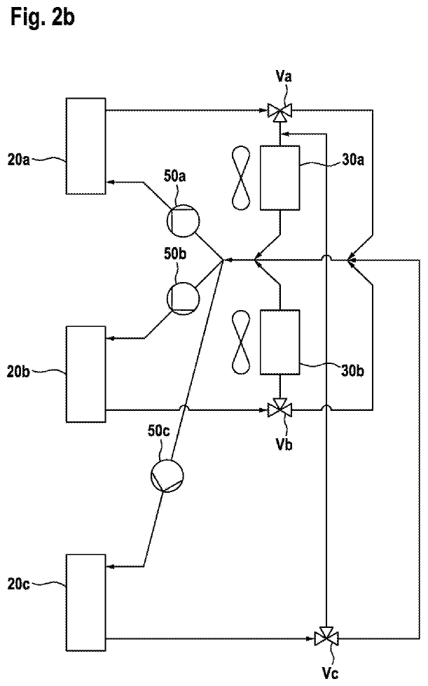

FIG. 2a shows a multi-box (also known as a fuel cell power module) cooling circuit 100, or multi-box for short, which consists of a plurality of interconnected one-box cooling circuits, or one-boxes for short. The multi-box shown is made up of three one-boxes. The specific cooling circuit interconnection of the one-boxes is very customer-specific and is therefore hidden behind the rectangle B in FIG. 2a. The rectangle B is intended to illustrate that a great advantage of the method presented here is that it is not relevant which branches, merges, further cooling devices/heating devices, coolant pumps, etc. are hidden behind rectangle B.

In principle, it does not matter where the pressure differential Δp, is determined in the direction of flow of the coolant in the coolant path for which the simulated current mass flow is to be determined using the method presented (preferably coolant path I in FIG. 1 or FIG. 2a). In this case, the pressure differential Δp can be measured either directly via a pressure differential sensor or calculated as the difference of the measured values of two separate pressure sensors.

When selecting the pressure-measuring points, however, it must be ensured that the pressure-measuring points are not too close to each other and that the determined pressure differential Δp is therefore within the range of the measurement noise of the pressure differential sensor or the separate pressure sensors. In this case, it is advantageous for a component to be located between the pressure measuring-points, e.g., the coolant pump or the component to be heated/cooled (e.g., the fuel cell stack) that causes a significant change in the pressure differential in the direction of flow. In other words, pressure differentials Δp between certain points are more advantageous than pressure differentials Δp between other points. Furthermore, if the temperature dependence of the coolant viscosity cannot be disregarded and therefore the temperature distribution between the pressure-measuring points also has an influence on the relationship between the mass flow and pressure differential Δp for a given system, it must be ensured that temperature measuring points are selected that can approximately describe this temperature distribution between the pressure-measuring points.

FIG. 2a shows five measuring points, a first measuring point S1, a second measuring point S2, a third measuring point S3, a fourth measuring point S4 and a fifth measuring point S5, as already shown in FIG. 1. The first measuring point S1 is arranged upstream of the coolant pump 50a, 50b, 50c. The second measuring point S2 is arranged upstream between the coolant pump 50 a, 50b, 50c and the component 20a, 20b, 20c to be heated/cooled, near the coolant output of the coolant pump 50a, 50b, 50c. The third measuring point S3 is arranged upstream between the coolant pump 50a, 50b, 50c and the component 20a, 20b, 20c to be heated/cooled, near the coolant input of the component 20a, 20b, 20c to be heated/cooled. The fourth measuring point S4 is located downstream near the coolant output of the component 20a, 20b, 20c to be heated/cooled. The fourth measuring point S5 is located downstream and away from coolant output of the component 20a, 20b, 20c to be heated/cooled.

The five measuring points S1, S2, S3, S4, S5 represent an exemplary selection of possible positions for temperature sensors or pressure sensors, the effects of which on the data-based black box model Mb or gray box Model Mg and consequently on the quality of the virtual mass flow sensor implemented in the software are explained hereinafter.

A pressure differential Δp between the first measuring point S1 and the second measuring point S2 is expected to be very high. This is advantageous for the black box model Mb or gray box Model Mg. In addition, pressure sensors are most likely already provided in conventional cooling circuits 100 at the first measuring point S1 and the second measuring point S2.

A pressure differential Δp between the first measuring point S1 and the third measuring point S3 is expected to be very high. This is advantageous for the black box model Mb or gray box Model Mg. In addition, a pressure sensors is most likely already provided in conventional cooling circuits 100 at the first measuring point S1. A pressure sensor is always provided at the third measuring point S3.

A pressure differential Δp between the second measuring point S2 and the third measuring point S3 is expected to be very low. This is disadvantageous for the black box model Mb or gray box Model Mg. As previously described, a pressure sensor is most likely already provided in conventional cooling circuits 100 at the second measuring point S2. A pressure sensor is always provided at the third measuring point S3.

A pressure differential Δp between the third measuring point S3 and the fourth measuring point S4 is expected to be very high. This is advantageous for the black box model Mb or gray box Model Mg. A pressure sensor is always provided at the third measuring point S3 and the fourth measuring point S4.

A pressure differential Δp between the fourth measuring point S4 and the fifth measuring point S5 is expected to be very low. This is disadvantageous for the black box model Mb or gray box Model Mg. A pressure sensor is always provided at the fourth measuring point S4. A pressure sensor is most likely not provided in conventional cooling circuits 100 at the fifth measuring point S5.

If a pressure differential Δp is defined between the first measuring point S1 and the second measuring point S2, a single temperature measurement at the first measuring point S1, the second measuring point S2 or the third measuring point S3, or near one of these measuring points, is sufficient. A temperature sensor is always provided at the third measuring point S3.

If a pressure differential Δp is defined between the first measuring point S1 and the third measuring point S3, a single temperature measurement at the first measuring point S1, the second measuring point S2 or the third measuring point S3, or near one of these measuring points, is sufficient. A temperature sensor is always provided at the third measuring point S3.

If a pressure differential Δp is defined between the second measuring point S2 and the third measuring point S3, a single temperature measurement at the first measuring point S1, the second measuring point S2 or the third measuring point S3, or near one of these measuring points, is sufficient. A temperature sensor is always provided at the third measuring point S3.

If a pressure differential Δp is defined between the third measuring point S3 and the fourth measuring point S4, a temperature measurement at the third measuring point S3 and the fourth second measuring point S4, or near one of these measuring points, is required. A temperature sensor is always provided at the third measuring point S3 and the fourth measuring point S4.

If a pressure differential Δp is defined between the fourth measuring point S4 and the fifth measuring point S5, a temperature measurement at the fourth measuring point S4 or the fifth second measuring point S5, or near one of these measuring points, is required. A temperature sensor is always provided at the fourth measuring point S4.

FIG. 2b shows an example of how three one-boxes could be specifically connected to a multi-box with regard to the cooling circuit. There are innumerable other vehicle-specific variations. The bypass valves Va, Vb, Vc and cooling devices 30a, 30b shown, as well as their interconnection, are hidden behind the rectangle B in FIG. 2a.

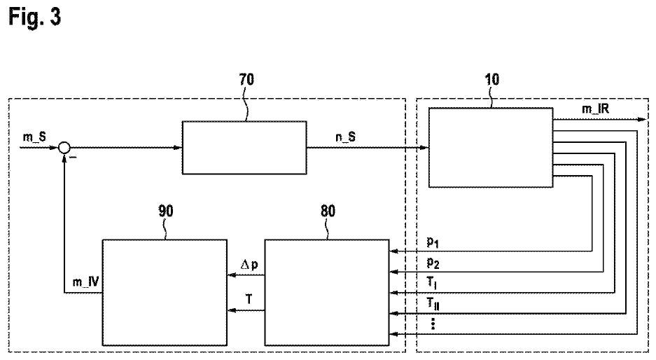

FIG. 3 shows a control loop for adjusting a target mass flow m_S over the target rotational speed n_s of a coolant pump of the coolant circuit 10. The coolant circuit 10 comprises a coolant pump 50 (in FIG. 1 and FIG. 2) regulated by a regulator 70. In other words, the regulator 70 sets a target rotational speed n_s of the coolant pump 50 (in FIG. 1 and FIG. 2) such that the real current mass flow m_IR of the coolant in the coolant path I (in FIG. 1) in which the component 20 to be cooled/heated is located, despite various unavoidable interferences (e.g., due to the presence of further pumps, valves, cooling devices, heating devices, etc. in the one-box or multi-box cooling circuit) and model errors (e.g., modeling inaccuracies in the model of bypass valve V (in FIG. 1) follows.

In the case of a multi-box consisting of three one-boxes, this control loop exists three times. In this case, the control section 10 is then not the cooling circuit 10 in FIG. 1 but the cooling circuit 100 in FIG. 2a.

Ideally (in the case of a single degree of freedom regulator, e.g. conventional PI(D) regulator with anti-wind-up), the regulator 70 would be provided with a difference between the target mass flow rate m_S and the real current mass flow m_IR of the coolant in the coolant path of the component 20 to be heated/cooled (in FIG. 1 and FIG. 2). However, in a production vehicle, the real current mass flow m_IR cannot be directly measured/calculated via a mass flow sensor or flow rate sensor (because it is then no longer present in the coolant circuit 10) and is therefore not available for the regulator 70.

The described method for determining the simulated current mass flow enables a relatively accurate approximation of the current mass flow m_IR with the determined simulated current mass flow m_IV. The determined simulated current mass flow m_IV which approximates the real current mass flow m_IR is not determined by a real mass flow sensor or flow rate sensor, but by a so-called virtual mass flow sensor 90. However, this simulated current mass flow m_IV can be used in the control loop for the input of the regulator 70, as it is calculated from the measured pressures (or pressure differential) at the pressure-measuring points and measured temperatures at the temperature measuring points, and thus indirectly receives the required feedback from the regulator section 10 and for a given system (system limit is from the first pressure-measuring point to the second pressure-measuring point), the physical relationship (pressure or pressure differential, mass flow rate, temperature-dependent viscosity) has been mapped in the data-based black box or gray box, which consists of the virtual mass flow sensor 90 or which was used as a characteristic map for its creation (the map was generated by means of a black box or gray box). Therefore, the method described enables the simulated current mass flow m_IV to be determined and the coolant pump 50 to be regulated based on the simulated current mass flow m_IV. The prior art control system described hereinabove for achieving the target mass flow rate m_S with its described numerous disadvantages can therefore be avoided.

In detail, the regulator 70 regulates the target rotational speed n_s of the coolant pump 50 (in FIG. 1 and FIG. 2). The current mass flow m_IR of the control circuit 10 is therefore indirectly regulated. In addition, a first pressure p1 is measured from a first pressure-measuring point and a second pressure p2 is measured from a second pressure-measuring point (or in the case of a pressure differential sensor instead of two pressure sensors, a pressure differential Δp between the pressure measuring points) as well as at least a first temperature and possibly a second temperature as well as possibly further temperatures. In the advantageous and preferred embodiment illustrated (the advantages were previously specified hereinabove; key phrase: “dimensionality of the input space”), a calculation unit 80 then calculates the inputs for a virtual mass flow sensor 90. In other words, the calculation unit 80 calculates a pressure differential Δp from the first pressure p1 and the second pressure p2. In addition, the calculation unit 80 calculates a representative temperature T that approximates the actual coolant distribution between the first pressure-measuring point and the second pressure-measuring point. Depending on the type of calculation, the calculation unit 80 can proceed with only the first temperature T_{I}, or it requires the second temperature T_{II} or further temperatures. The alternative is no temperature if it can again be expected that the temperature dependence of the coolant viscosity can be disregarded for a given system.

In the advantageous, preferred embodiment shown, then the pressure differential Δp and the representative temperature T then serve as the input to the virtual mass flow sensor 90, which is modeled in particular by the data-based model in order to determine the simulated current mass flow m_IV. The simulated current mass flow m_IV therefore represents a calculated approximation of the current mass flow m_IR, which can be used as an input for the regulator 70. The suitability of the current mass flow m_IV simulated in this way to be used for a controller is a significant positive feature of the method presented, which is not fulfilled by the method known in the prior art.

Additional remark: If, contrary to expectations, due an unfavorable positioning, the pressure-measuring points are not in the first coolant path I (in FIG. 1 and FIG. 2) in which the component to be heated/cooled is located, the mass flow ratio between the different coolant paths must also be calculated from the reported position of the bypass valve (V in FIG. 1). By additionally using this mass flow ratio, the coolant mass flow in the first coolant path I in which the component to be heated/cooled is located can still be calculated and thus a control loop for adjusting the target mass flow in this first coolant path I can also be established again.

In the following, a single one-box is considered in a multi-box coolant circuit (see FIG. 2): The current mass flow prevailing in the coolant path I of the one-box under consideration is not only influenced as desired by the coolant pump 50 of the one box, but other components present in the entire cooling circuit 100 (e.g., coolant pumps, valves, radiators, heater, etc.) also influence the resulting current mass flow of the coolant in the first coolant path I due to the couplings (i.e. merges and branches of the coolant paths) in the multi-box coolant circuit, depending on the operating state. These undesired influences on the first coolant path I of the one-box under consideration thus represent dynamically changing disturbance variables. However, due to the use of the control loop shown in FIG. 3, these can be compensated or largely compensated for. The following briefly demonstrates how this works in the control loop in FIG. 3: If the simulated current mass flow in coolant path I of the one-box under consideration is greater or less than the target mass flow m_S, the controller 70 will then ensure that the target rotational speed n_s of the coolant pump 50 of the one-box under consideration (in FIG. 2) is reduced or increased and thus adjust the target mass flow rate m_S required for the one-box under consideration.

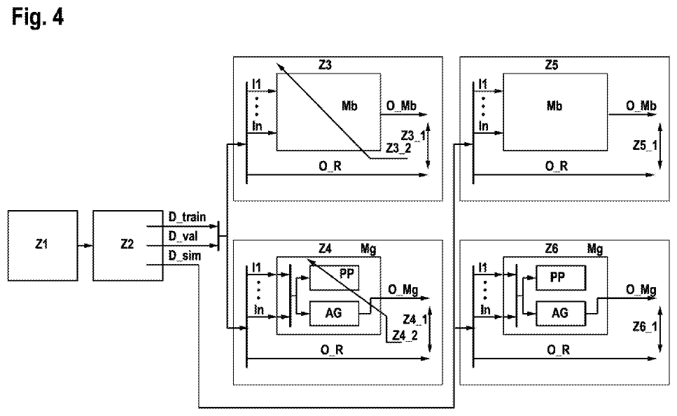

FIG. 4 schematically shows the creation and review of the black box model Mb and the gray box model Mg.

In a first step Z1, measured signals that arise, for example, during the various tests performed on the test bench or test vehicle anyway or during test operation, are divided into relevant inputs and outputs of the mathematical model to be identified (i.e., the black box model Mb or the gray box model Mg). In this case, the output of the mathematical model and thus the target variable of the training or system identification is the measured current mass flow m_IM, and the inputs are two pressure signals or the differential pressure and at least one temperature signal.

In a second step Z2, the data provided in the first step Z1, i.e., the data with the measured current mass flow m_IM, the two pressure signals or the differential pressure and the at least one temperature signal, are divided into training data D_train, validation data D_val and simulation data D_sim. In this case, the validation data D_val are only needed for certain identification algorithms (e.g., for specific neural networks).

In a third step Z3, the black box model Mb (e.g., neural network, multi-dimensional polynomial, multi-dimensional spline, etc.) is identified. The data divided in the second step Z2, in particular the training data D_train and the validation data D_val, are transferred as the first input I1 to the nth input In to the black box model, which generates a black box model output O_Mb, i.e., a simulated current mass flow. This black box model output O_Mb is compared with the measured system output O_R in a further step Z3_1. An error measure is calculated as a result of this comparison. By optimizing (i.e., minimizing) this error measure, the model parameters of the black box model Mb are adapted by the identification algorithm in a further step Z3_2.

Similarly, in a fourth step Z4 the gray box model Mg is identified. The data divided in the second step Z2, in particular the training data D_train and the validation data D_val, are transferred as the first input I1 to the nth input In to the gray box model Mg, which generates a gray box model output O_Mg, i.e., a simulated current mass flow. As described, the gray box model Mg comprises physical parameters PP that generate the gray box model output O_Mb by analytical equations AG. The gray box model output O_Mg is compared with the measured system output O_R in a further step Z4_1. An error measure is calculated as a result of this comparison. By optimizing (i.e., minimizing) this error measure, the model parameters of the gray box model Mg are adapted by the identification algorithm in a further step Z4_2. The parameters PP can either be defined as constant or as variable and calculated as the output signal of a black box model (neural network, multidimensional polynomial, multidimensional spline, etc.), depending on the input signals (e.g., specific selection of the inputs I1 to In).

To check the quality of the black box model Mb, in a fifth step Z5 the data divided in the second step Z2, in particular the simulation data D_sim, are transferred as the first input I1 to nth input In to the black box model Mb, which generates a black box model output O_Mb, i.e., a simulated current mass flow. In a further step Z5_1, a fault analysis is performed that compares the black box model output O_Mb with the measured system output O_R. It is therefore checked whether for a data set (i.e., simulation data D_sim) that was not used for the identification of the black box model Mb, the black box model Mb can reproduce the measured system output O_R sufficiently accurately and therefore has what is referred to as generalization capability.

To check the quality of the gray box model Mg, in a sixth step Z6 the data divided in the second step Z2, in particular the simulation data D_sim, are transferred as the first input I1 to nth input In to the gray box model Mg, which generates a gray box model output O_Mg, i.e., a simulated current mass flow m_IV. In a further step Z6_1, a fault analysis is performed that compares the gray box model output O_Mg with the measured system output O_R. It is therefore checked whether for a data set (i.e., simulation data D_sim) that was not used for the identification of the gray box model Mg, the gray box model Mg can reproduce the measured system output O_R sufficiently accurately and thus has what is referred to as generalization capability.

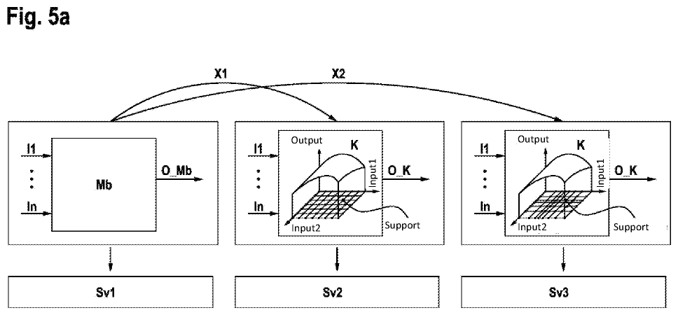

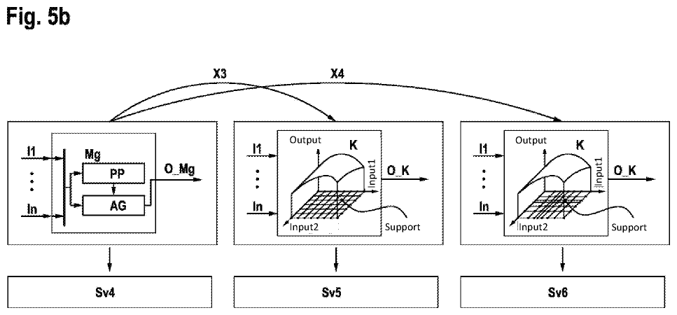

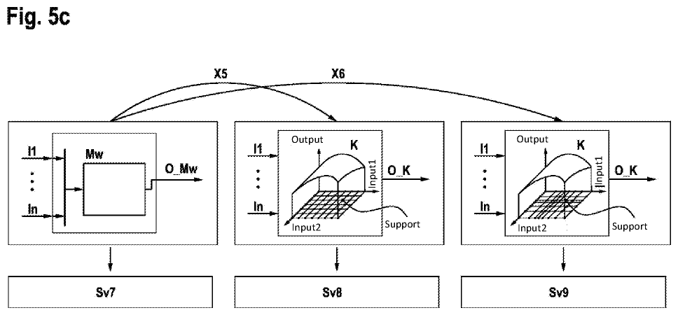

FIG. 5a shows various implementation variants of the virtual mass flow sensor. The black box model Mb (e.g., neural network, multi-dimensional polynomial, multi-dimensional spline, etc.) itself can represent a first virtual mass flow sensor Sv1 when implemented (directly) in software. The black box model Mb generates a black box model output O_Mb from a first input I1 to nth input In.

Alternatively, as shown in step X1, a characteristic map K is calibrated via the black box model Mb. In this case, the calibration of the characteristic map K is performed, in which the developer/calibrator specifies (e.g., equidistant) positions for the support points for the independent quantities of the characteristic map K, i.e., for the inputs I1 to In. The black box model Mb is then used to calculate the values of the associated dependent variables of the characteristic map (in this case the simulated current mass flow) for these predetermined values of the independent variables of the characteristic map K. In other words, the predetermined values of the independent variables of the characteristic map K define the data points of the input signals I1 to In with which the black box model Mb is simulated. The data points of the simulated output of the black box model Mb (in this case the simulated current mass flow) then represent the values of the dependent variables of the characteristic map K associated with the predetermined values of the independent variables. Using the values determined in this way, the characteristic map K is calibrated. The characteristic map K generates the model output O_K, i.e., the simulated current mass flow m_IV from the inputs I1. In this case, the model output O_K for data points of the inputs I1 to In that do not lie on the support point values of the characteristic map K is determined by means of (e.g., linear, square, etc.) interpolation. Therefore, when the characteristic map K is implemented in software, it represents a second virtual mass flow sensor Sv2.

Alternatively, as shown in step X2, a characteristic map K is calibrated via the black box model Mb and a mathematical optimization of the support point positions of the characteristic map K is also performed. Unlike in step X1, however, in step X2 for the independent variables of the characteristic map K, i.e. for the inputs I1 to In, the positions of the support points (i.e., the values {x_{1,k1}, x_{2,k}_{₂}}) are not specified by the developer/calibrator, but are determined by a mathematical optimization algorithm (e.g., sequential quadratic programming). The cost function J(x₁, x₂) of this optimization was previously specified hereinabove. Δpart from the selection of the positions of the support locations, the method in step X2 is the same as in X1 and will therefore not be described further herein. Therefore, when the characteristic map K is implemented in software, it represents a third virtual mass flow sensor Sv3.

FIG. 5b shows various implementation variants of the virtual mass flow sensor. The gray box model Mg itself can represent a fourth virtual mass flow sensor Sv4 when implemented as software. The gray box model Mg generates a gray box model output O_Mg from a first input I1 to nth input In.

Alternatively, as shown in step X3, a characteristic map K is calibrated via the gray box model Mg. Δpart from the fact that the gray box model Mg is used instead of the black box model Mb, the procedure in step X3 does not differ from that in step X1 (see FIG. 5a) and is therefore not described further herein. The characteristic map K generates a characteristic map model output O_K from a first input I1 to an nth input In. Therefore, when the characteristic map K is implemented in software, it represents a fifth virtual mass flow sensor Sv5.

Alternatively, as shown in step X4, a characteristic map K is calibrated via the gray box model Mg and a mathematical optimization of the support point positions of the characteristic map K is also performed. Δpart from the fact that the gray box model Mg is used instead of the black box model Mb, the procedure in step X4 does not differ from that in step X2 (see FIG. 5a) and is therefore not described further here. The characteristic map K also generates a characteristic map model output O_K, i.e., the simulated current mass flow m_IV, from a first input I1 to nth input In. Therefore, when the characteristic map K is implemented in software, it represents a sixth virtual mass flow sensor Sv6.

FIG. 5c shows various implementation variants of the virtual mass flow sensor. The white box model Mw itself can represent a seventh virtual mass flow sensor Sv7 when implemented in software. The white box model Mw generates a white box model output O_Mw from a first input I1 to nth input In.

Alternatively, as shown in step X5, a characteristic map K is calibrated via the white box model Mw. Δpart from the fact that the white box model Mw is used instead of the black box model Mb, the procedure in step X3 does not differ from that in step X1 (see FIG. 6a) and is therefore not described further here. The characteristic map K generates a characteristic map model output O_K from a first input I1 to an nth input In. Therefore, when the characteristic map K is implemented in software, it represents an eighth virtual mass flow sensor Sv8.

Alternatively, as shown in step X6, a characteristic map K is calibrated via the white box model Mw and a mathematical optimization of the support point positions of the characteristic map K is also performed. Δpart from the fact that the white box model Mw is used instead of the black box model Mb, the procedure in step X6 does not differ from that in step X2 (see FIG. 5a) and is therefore not described further here. The characteristic map K also generates a characteristic map model output O_K from a first input I1 to an nth input In. Therefore, when the characteristic map K is implemented in software, it represents a ninth virtual mass flow sensor Sv9.

1. A method for determining a simulated current mass flow (m_IV) as a substitute for a current mass flow (m_IM) that cannot be measured in a field/production vehicle, in a coolant circuit (10,100) for heating/cooling a component (20) to be heated/cooled, the method comprising the steps of:
receiving pressure data (D_P), wherein the pressure data (D_P) comprise a first pressure (p1) in the coolant circuit (10,100) and a second pressure (p2) in the coolant circuit (10,100), wherein the first pressure (p1) is provided from a first pressure-measuring point with a first pressure sensor and the second pressure (p2) is provided from a second pressure-measuring point with a second pressure sensor, or the pressure data (D_P) comprise a pressure differential (Δp) in the coolant circuit (10,100), wherein the pressure differential (Δp) between the first pressure-measuring point and the second pressure-measuring point is provided; wherein the first pressure-measuring point is upstream of the second pressure-measuring point and wherein the first pressure-measuring point and the second pressure-measuring point are in the same coolant path of the coolant circuit (10,100);
determining the simulated current mass flow (m_IV) of the coolant a computer executing a mathematical model (M) configured to determine the current mass flow based on the pressure data (D_P).

2. The method according to claim 1,
wherein the mathematical model (M) comprises an identified black box model (Mb) that is purely data-based.

3. The method according to claim 2,
wherein the black box model (Mb) comprises a polynomial, a spline, or a machine learning model.

4. The method according to claim 1,
wherein the mathematical model (M) comprises an identified gray box model (Mg) that models at least portions of a physical relationship between pressure, temperature, and mass flow.

5. The method according to claim 1,
wherein the mathematical model (M) comprises a white box model (Mw) that purely analytically models the physical relationship between pressure, temperature, and/or heat flows and mass flow.

6. The method according to claim 1,
wherein the mathematical model (M) calibrates a characteristic map (K), wherein the simulated current mass flow (m_IV) is determined based on the characteristic map (K), wherein the characteristic map (K) comprises a plurality of data points that associate the simulated current mass flow (m_IV) with the pressure data (D_P) and/or temperature data (D_T).

7. The method according to claim 1, comprising the following steps:
receiving temperature data (D_T) of the coolant circuit (10,100);
determining a representative temperature (T) from the temperature data (D_T), wherein the representative temperature (T) approximates the temperature distribution of the coolant between the first pressure-measuring point and the second pressure-measuring point;
determining the simulated current mass flow (m_IV) of the coolant with the aid of the mathematical model (M) that determines the current mass flow based on the pressure data (D_P) and the temperature data (D_T), or based on the pressure data (D_P) and the determined representative temperature (T).

8. The method according to claim 7,
wherein the representative temperature (T) comprises a linear interpolation between a temperature at the coolant inlet of a heat source or heat sink, and a temperature at the coolant outlet of a heat source or heat sink.

9. The method according to claim 2,
wherein the mathematical model (M) was trained on a test bench or test vehicle, wherein the test bench or test vehicle comprises at least one flow rate sensor and/or mass flow sensor for determining the measured mass flow (m_IM).

10. The method according to claim 9,
wherein the training of the mathematical model (M) comprises receiving mass flow data (D_M), wherein for receiving the mass flow data (D_M), the mass flow ratios between the different coolant paths are additionally considered as mass flow ratio data (D_MV) depending on the position of the at least one flow rate sensor and/or mass flow sensor.

11. An apparatus for determining a simulated current mass flow (m_IV) as a substitute for a current mass flow (m_IM) that cannot be measured in a field/production vehicle, in a coolant circuit (10,100) for cooling or heating a component (20) to be heated/cooled, said apparatus being configured to perform the method according to claim 1.

12. (canceled)
